(19) United States
(12) Patent Application Publication
(10) Pub. No.: US 2025/0296420 A1
(43) Pub. Date: Sep. 25, 2025

(54) VEHICLE

(71) Applicant: TOYOTA JIDOSHA KABUSHIKI KAISHA, Aichi-ken (JP)

(72) Inventors: Akio UOTANI, Nagoya-shi (JP); Dexu ZHANG, Mishima-shi (JP); Yoshinobu KUROYAMA, Aichi-ken (JP); Daisuke KAMESAKI, Okazaki-shi (JP); Seigo FUJISHIMA, Miyoshi-shi (JP); Yuki TAKAHASHI, Miyoshi-shi (JP)

(21) Appl. No.: 19/043,522

(22) Filed: Feb. 3, 2025

(30) Foreign Application Priority Data
Mar. 21, 2024 (JP) 2024-044935

(51) Int. Cl. B60K 1/04; B60K 6/28; B60R 13/08; H01M 10/658; H01M 50/249; H01M 50/358

(52) U.S. Cl. CPC B60K 1/04; B60K 6/28; B60R 13/0815; B60R 13/0869; H01M 10/658; H01M 50/249; H01M 50/358; B60K 2001/0438; B60Y 2200/91; B60Y 2200/92; H01M 2220/20

(57) ABSTRACT

A vehicle includes: a vehicle body provided with a boarding space; and a power storage device disposed below the boarding space, wherein the power storage device includes one or more power storage stacks and an accommodation case that accommodates the one or more power storage stacks, the accommodation case has a lower case in which the one or more power storage stacks are disposed, and a plurality of wall portions that partition a region in which the one or more power storage stacks are disposed, a gas-discharge path through which gas discharged from the one or more power storage stacks is flowable is provided inside each of the plurality of wall portions, and a heat insulating member is disposed between each of the plurality of wall portions and the boarding space.

### CROSS REFERENCE TO RELATED APPLICATIONS

This nonprovisional application is based on Japanese Patent Application No. 2024-044935 filed on Mar. 21, 2024 with the Japan Patent Office, the entire contents of which are hereby incorporated by reference.

### BACKGROUND

### Field

The present disclosure relates to a vehicle, particularly, to a vehicle including a power storage device.

### Description of the Background Art

As a conventional power storage device, WO 2020/134054 discloses a structure in which a portion of an accommodation case that accommodates a plurality of power storage stacks is constituted of a hollow member and a hollow portion of the hollow member is used as a gas-discharge path for gas generated from a power storage stack.

### SUMMARY

However, since the gas generated from the power storage stack has a considerably high temperature, there is a concern that when the power storage device described in WO 2020/134054 is mounted on a vehicle without taking any countermeasure, heat is transferred to a boarding space from the portion of the accommodation case that constitutes the gas-discharge path.

The present disclosure has been made in view of the above-described problem, and has an object to provide a vehicle so as to suppress transfer of heat to a boarding space when gas is discharged from a power storage device.

A vehicle according to the present disclosure includes: a vehicle body provided with a boarding space; and a power storage device disposed below the boarding space. The power storage device includes one or more power storage stacks and an accommodation case that accommodates the one or more power storage stacks. The accommodation case has a lower case in which the one or more power storage stacks are disposed, and a plurality of wall portions that partition a region in which the one or more power storage stacks are disposed. A gas-discharge path through which gas discharged from the one or more power storage stacks is flowable is provided inside each of the plurality of wall portions. A heat insulating member is disposed between each of the plurality of wall portions and the boarding space.

According to the above-described configuration, since the heat insulating member is disposed between the boarding space and each of the plurality of wall portions constituting the gas-discharge path, it is possible to suppress heat from being transferred from the wall portion to the boarding space even when the gas discharged from the power storage stacks flows inside the wall portion.

In the vehicle according to the present disclosure, the accommodation case may have an upper member that seals an opening of the lower case. The heat insulating member may be disposed between each of the plurality of wall portions and the upper member.

According to the above-described configuration, the heat from the gas flowing through the gas-discharge path can be suppressed from being transferred from each of the plurality of wall portions to the upper member, thereby suppressing the heat from being transferred from the upper member to the boarding space.

In the vehicle according to the present disclosure, a cross member that constitutes a portion of a frame of the vehicle body may be disposed between the boarding space and the accommodation case. A portion of the heat insulating member may be disposed between the cross member and the accommodation case.

According to the above-described configuration, the heat from the gas flowing through the gas-discharge path can be suppressed from being transferred from the accommodation case to the cross member, thereby suppressing the heat from being transferred from the cross member to the boarding space.

The vehicle according to the present disclosure may further include an electrical device disposed between the boarding space and the power storage device. The heat insulating member may include a first heat insulating member disposed between the electrical device and a portion of the plurality of wall portions located below the electrical device.

According to the above-described configuration, the heat from the gas flowing through the gas-discharge path can be suppressed from being transferred from the wall portion to the electrical device.

The vehicle according to the present disclosure may include a pair of front seats and a rear seat each disposed in the boarding space. The heat insulating member may include a second heat insulating member disposed between each of the pair of front seats and a portion of the plurality of wall portions located below each of the pair of front seats, and a third heat insulating member disposed between the rear seat and a portion of the plurality of wall portions located below the rear seat.

According to the above-described configuration, the heat from the gas flowing through the gas-discharge path can be suppressed from being transferred from the wall portion to each of the pair of the front seats and the rear seat.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram showing a vehicle according to a first embodiment.

FIG. 2 is a schematic cross sectional view showing a state in which the power storage device according to the first embodiment is mounted on a vehicle body.

FIG. 3 is a schematic exploded perspective view of the power storage device according to the first embodiment.

FIG. 4 is a schematic exploded perspective view of a power storage device according to a second embodiment.

FIG. 5 is a schematic exploded perspective view of a power storage device according to a third embodiment.

### DESCRIPTION OF THE PREFERRED EMBODIMENTS

Hereinafter, embodiments of the present disclosure will be described in detail with reference to figures. It should be noted that in the embodiments described below, the same or common portions are given the same reference characters in the figures and are not described repeatedly.

### First Embodiment

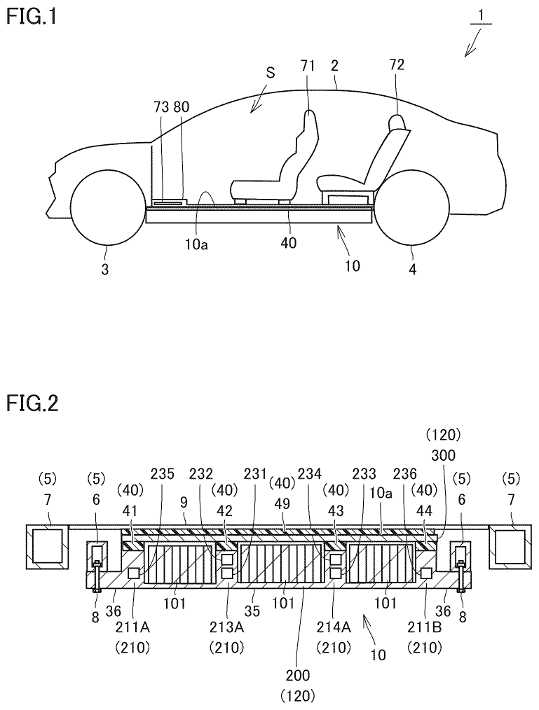

FIG. 1 is a schematic diagram showing a vehicle according to a first embodiment. FIG. 2 is a schematic cross sectional view showing a state in which the power storage device according to the first embodiment is mounted on a vehicle body. A vehicle 1 according to the first embodiment will be described with reference to FIGS. 1 and 2.

Vehicle 1 is a hybrid electric vehicle that can travel using motive power from at least one of a motor and an engine, or a battery electric vehicle that travels using driving power obtained by electric energy.

As shown in FIG. 1, vehicle 1 includes a vehicle main body (vehicle body) 2, front wheels 3, rear wheels 4, a power storage device 10, a heat insulating member 40, a pair of front seats 71, a rear seat 72, an electrical device 73, and a floor carpet 80. Vehicle main body 2 includes a boarding space S. Boarding space S is located above floor carpet 80. The pair of front seats 71 and rear seat 72 are disposed in boarding space S. The pair of front seats 71 are arranged side by side at an interval in a width direction of the vehicle. Rear seat 72 is disposed rearward with respect to the pair of front seats 71. Rear seat 72 extends in the width direction of the vehicle.

Power storage device 10 is disposed below boarding space S. Power storage device 10 is fixed to vehicle main body 2. Power storage device 10 has an upper surface 10a. Upper surface 10a also functions as a floor member that defines a vehicle compartment. Floor carpet 80 is disposed on upper surface 10a. Floor carpet 80 may be disposed above a cross member 9 (see FIG. 2) described later. Electrical device 73 is disposed on the front side of vehicle 1 between floor carpet 80 and upper surface 10a. Electrical device 73 is, for example, an in-vehicle ECU. Electrical device 73 is disposed, for example, on the passenger seat side of the pair of front seats 71. Electrical device 73 is disposed near the feet of an occupant sitting on the passenger seat side.

Heat insulating member 40 suppresses heat caused by gas from being transferred to boarding space S when the gas is discharged inside power storage device as described later.

As shown in FIG. 2, vehicle main body 2 includes a frame member 5. Frame member 5 includes a pair of side members 6 and a pair of side sills 7. The pair of side sills 7 are disposed on both end sides of vehicle 1 in the width direction. The pair of side members 6 are disposed internal to the pair of side sills 7 at a distance therebetween. Each of the pair of side members 6 and the pair of side sills 7 extends along a frontward/rearward direction of vehicle 1.

The pair of side members 6 are separated from each other in the width direction of vehicle 1. A main body portion 35 of power storage device 10 is disposed in a space between the pair of side members 6. A clearance is provided between main body portion 35 and each of the pair of side members 6. Thus, even when vehicle 1 is collided at its lateral side, an impact can be suppressed from being input to power storage device 10.

Fixed portions 36 are provided at both side surfaces of main body portion 35 in the width direction of vehicle 1. Fixed portions 36 are fixed to the pair of side members 6 by fastening members 8.

Frame member 5 also includes cross member 9. Cross member 9 is provided so as to extend from one side sill 7 to the other side sill 7 above power storage device 10. Power storage device 10 is fastened and fixed to cross member 9. In the present embodiment, it is illustratively described that a portion 49 of heat insulating member 40 is disposed between cross member 9 and upper surface 10a; however, the heat insulating member may not be disposed between cross member 9 and accommodation case 120.

In the above description, it has been illustratively described that frame member includes the pair of side members 6 and the pair of side sills 7; however, it is not limited thereto. The pair of side sills 7 may also have the function of the pair of side members 6. In this case, the pair of side members 6 can be omitted, and fixed portions 36 may be fixed to the pair of side sills 7.

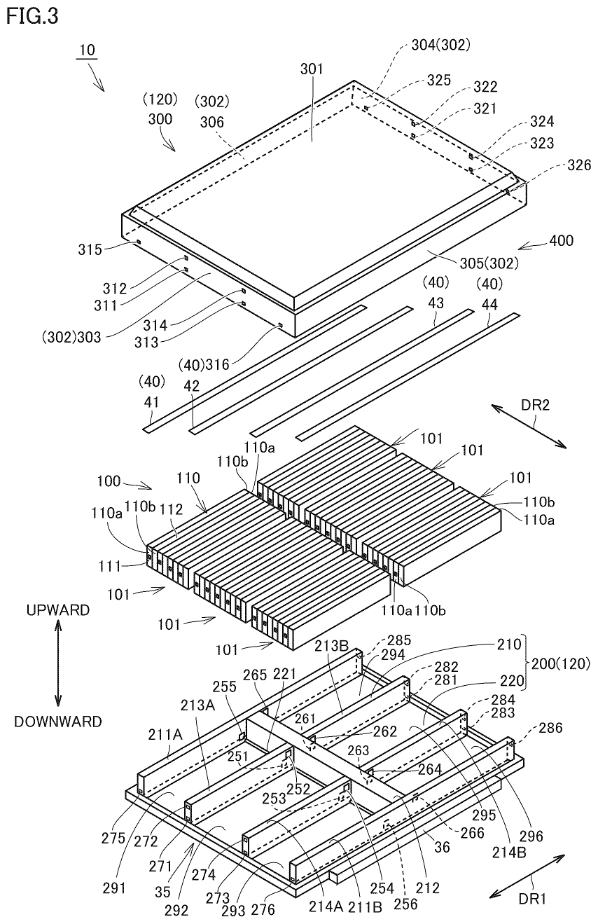

FIG. 3 is a schematic exploded perspective view of the power storage device according to the first embodiment. A detailed structure of power storage device 10 will be described with reference to FIGS. 2 and 3.

As shown in FIGS. 2 and 3, power storage device 10 includes a power storage module 100 and an accommodation case 120. Power storage module 100 and heat insulating member 40 are accommodated in accommodation case 20.

Power storage module 100 includes a plurality of power storage stacks 101. The plurality of power storage stacks 101 are arranged in the form of a matrix in accommodation case 120. When a first direction (DR1) is defined as a column direction and a second direction (DR2) is defined as a row direction, the plurality of power storage stacks 101 are arranged in three rows and two columns. It should be noted that the first direction is parallel to the frontward/rearward direction of vehicle 1 in a mounted state in which power storage device 10 is mounted on vehicle main body 2, for example. The second direction is orthogonal to the first direction and is parallel to a leftward/rightward direction of vehicle 1 in the mounted state. The plurality of power storage stacks 101 are electrically connected in series.

Each of power storage stacks 101 includes a plurality of unit cells 110. In each of power storage stacks 101, the plurality of unit cells 110 are arranged in the second direction. The plurality of unit cells 110 are electrically connected in series. Each of unit cells 110 has an elongated shape having its long-side direction corresponding to the first direction. Unit cell 110 has a flat rectangular parallelepiped shape having a thickness in the second direction.

Unit cell 110 includes a housing 112, and one or a plurality of electrode assemblies are accommodated in housing 112.

When one electrode assembly is accommodated in housing 112, the electrode assembly has a shape extending in the long-side direction. The electrode assembly may be a stacked type electrode assembly in which a negative electrode sheet, a separator, and a positive electrode sheet are stacked, or may be a wound type electrode assembly in which a negative electrode sheet, a separator, and a positive electrode sheet are wound.

When a plurality of electrode assemblies are accommodated in housing 112, the plurality of electrode assemblies are arranged side by side in the long-side direction and are connected in series. Also in this case, each of the electrode assemblies may be the stacked type electrode assembly or the wound type electrode assembly.

Unit cell 110 is a secondary battery such as a nickel-metal hydride battery or a lithium ion battery. Unit cell 110 may use a liquid electrolyte or a solid electrolyte. Unit cell 110 may be a chargeable/dischargeable capacitor.

Housing 112 is composed of, for example, a metal material such as aluminum. Housing 112 includes a first end surface 110a and a second end surface 110b arranged in the first direction, and a gas-discharge valve 111. Gas-discharge valve 111 is formed in first end surface 110a. When internal pressure of housing 112 becomes more than a predetermined value, gas-discharge valve 111 is opened to discharge the gas in housing 112 to the outside of housing 112.

In each of power storage stacks 101, the plurality of unit cells 110 are arranged in the second direction such that gas-discharge valves 111 are alternately located on one side in the first direction and the other side in the first direction. That is, the plurality of unit cells 110 are arranged such that first end surfaces 110a and second end surfaces 110b are alternately arranged in the second direction on each of the one side and the other side in the first direction.

Accommodation case 120 includes an upper member 300 and a lower case 200. Upper member 300 has, for example, a substantially box shape that is opened downward. Upper cover 300 includes a top plate 301 and a peripheral wall 302. Peripheral wall 302 is formed so as to extend downward from an outer peripheral edge portion of top plate 301. Peripheral wall 302 includes: end walls 303, 304 arranged in the first direction; and side walls 305, 306 arranged in the second direction.

External discharge ports 311 to 316 are formed in end wall 303. Moreover, external discharge ports 321 to 326 are formed in end wall 304. External discharge ports 311 to 316 are through holes each extending through end wall 303, and external discharge ports 321 to 326 are through holes each extending through end wall 304.

Lower case 200 includes a plurality of wall portions 210, a bottom plate 220, and a sealing member 221. The plurality of wall portions 210 and sealing member 221 are provided on an upper surface of bottom plate 220. Lower case 200 is constituted of main body portion 35 and fixed portions 36. Main body portion 35 includes the plurality of wall portions 210 and bottom plate 220. Fixed portions 36 are provided in both side surfaces of main body portion 35 in the second direction.

The plurality of wall portions 210 include a pair of side walls 211A, 211B, a dividing wall 212, partition walls 213A, 213B, and partition walls 214A, 214B. The pair of side walls 211A, 211B, dividing wall 212, partition walls 213A, 213B, and partition walls 214A, 214B are each provided to rise from bottom plate 220. The pair of side walls 211A, 211B, partition walls 213A, 213B, and partition walls 214A, 214B each extend in the first direction. A gas-discharge path through which gas discharged from a power storage stack 101 is flowable is provided inside each of the pair of side walls 211A, 211B, partition walls 213A, 213B, and partition walls 214A, 214B as described later.

The pair of side walls 211A, 211B (first side wall and second side wall) are disposed at an interval in the second direction. The pair of side walls 211A, 211B are disposed on both sides of the bottom plate in the second direction.

Dividing wall 212 is formed on the upper surface of bottom plate 220 so as to extend in the second direction. Dividing wall 212 is disposed to pass through a central portion of bottom plate 220 in first direction DR1. Dividing wall 212 divides, in the first direction, the space in accommodation case 120.

Partition walls 213A, 214A (first partition wall and second partition wall) are disposed in a space, in accommodation case 120 divided by dividing wall 212, on one side in the first direction. Partition walls 213A, 214A are disposed between the pair of side walls 211A, 211B on one side in the first direction. Partition walls 213A, 214A are separated from the pair of side walls 211A, 211B and are disposed at an interval in the second direction.

Partition walls 213A, 214A divide, in the second direction, the space in accommodation case 120 on one side in the first direction with respect to dividing wall 212. Specifically, partition walls 213A, 214A divide, into three in the second direction, the space in accommodation case 120 on one side in the first direction. In the space in the accommodation case on one side in the first direction, power storage stack 101 is disposed in each of regions (a first region 291, a second region 292, and a third region 293) partitioned by the pair of side walls 211A, 211B and partition walls 213A, 214A.

Partition walls 213B, 214B (third partition wall and fourth partition wall) are disposed in a space, in accommodation case 120 partitioned by dividing wall 212, on the other side in the first direction. Partition walls 213B, 214B are disposed between the pair of side walls 211A, 211B on the other side in the first direction. Partition walls 213B, 214B are separated from the pair of side walls 211A, 211B and are disposed at an interval in the second direction.

Partition walls 213B, 214B divide, in the second direction, the space in accommodation case 120 on the other side in the first direction with respect to dividing wall 212. Specifically, partition walls 213B, 214B divide, into three in the second direction, the space in accommodation case 120 on the other side in the first direction. In the space in the accommodation case on the other side in the first direction, power storage stack 101 is disposed in each of regions (a fourth region 294, a fifth region 295, and a sixth region 296) partitioned by the pair of side walls 211A, 211B and partition walls 213B, 214B.

Side wall 211A is provided with a discharge port 275, a discharge port 285, and side wall openings 255, 265. Discharge port 275 is provided in an end surface of side wall 211A on one side in the first direction. Discharge port 285 is provided in an end surface of side wall 211A on the other side in the first direction.

Side wall opening 255 is opened toward first region 291. Specifically, side wall opening 255 is opened toward first region 291 on the dividing wall 212 side. A gas-discharge path 235 (see FIG. 2) is provided inside side wall 211A, and side wall opening 255 communicates with discharge port 275 via gas-discharge path 235.

Side wall opening 265 is opened toward fourth region 294. Specifically, side wall opening 265 is opened toward fourth region 294 on the dividing wall 212 side. A gas-discharge path (not shown) communicating with side wall opening 265 is provided inside side wall 211A, and side wall opening 265 communicates with discharge port 285 via the gas-discharge path.

Similarly, side wall 211B is provided with a discharge port 276, a discharge port 286, and side wall openings 256, 266. Discharge port 276 is provided in an end surface of side wall 211B on one side in the first direction. Discharge port 286 is provided in an end surface of side wall 211B on the other side in the first direction.

Side wall opening 256 is opened toward third region 293. Specifically, side wall opening 256 is opened toward third region 293 on the dividing wall 212 side. A gas-discharge path 236 (see FIG. 2) is provided inside side wall 211B, and side wall opening 256 communicates with discharge port 276 via gas-discharge path 236.

Side wall opening 266 is opened toward sixth region 296. Specifically, side wall opening 266 is opened toward sixth region 296 on the dividing wall 212 side. A gas-discharge path (not shown) communicating with side wall opening 266 is provided inside side wall 211B, and side wall opening 266 communicates with discharge port 286 via the gas-discharge path.

Partition wall 213A is provided with discharge ports 271, 272 and openings 251, 252. Further, gas-discharge paths 231, 232 (see FIG. 2) are provided inside partition wall 213A. Discharge ports 271, 272 are provided in an end surface of partition wall 213A on one side in the first direction. Discharge ports 271, 272 are provided side by side in the upward/downward direction. Discharge port 272 is located above discharge port 271, for example.

Opening 251 is provided in a side surface of partition wall 213A on one side in the second direction. Opening 251 is opened toward first region 291. Opening 251 communicates with discharge port 271 via gas-discharge path 231.

Opening 252 is provided in a side surface of partition wall 213A on the other side in the second direction. Opening 252 is opened toward second region 292. Opening 252 communicates with discharge port 272 via gas-discharge path 232.

Partition wall 214A is provided with discharge ports 273, 274 and openings 253, 254. Further, gas-discharge paths 233, 234 (see FIG. 2) are provided inside partition wall 214A. Discharge ports 273, 274 are provided in an end surface of partition wall 214A on one side in the first direction. Discharge ports 273, 274 are provided side by side in the upward/downward direction. Discharge port 274 is located above discharge port 273, for example.

Opening 253 is provided in a side surface of partition wall 214A on one side in the second direction. Opening 253 is opened toward second region 292. Opening 253 communicates with discharge port 273 via gas-discharge path 233.

Opening 254 is provided in a side surface of partition wall 214A on the other side in the second direction. Opening 254 is opened toward third region 293. Opening 254 communicates with discharge port 274 via gas-discharge path 234.

Partition wall 213B is provided with discharge ports 281, 282 and openings 261, 262. As with partition wall 213A, two gas-discharge paths (not shown) are provided inside partition wall 213B. Discharge ports 281, 282 are provided in an end surface of partition wall 213B on the other side in the first direction. Discharge ports 281, 282 are provided side by side in the upward/downward direction. Discharge port 282 is located above discharge port 281, for example.

Opening 261 is provided in a side surface of partition wall 213B on one side in the second direction. Opening 261 is opened toward fourth region 294. Opening 261 communicates with discharge port 281 via one of the two gas-discharge paths described above.

Opening 262 is provided in a side surface of partition wall 213B on the other side in the second direction. Opening 262 is opened toward fifth region 295. Opening 262 communicates with discharge port 282 via the other of the two gas-discharge paths described above.

Partition wall 214B is provided with discharge ports 283, 284, and openings 263, 264. As with partition wall 214A, two gas-discharge paths (not shown) are provided inside partition wall 214B. Discharge ports 283, 284 are provided in an end surface of partition wall 214B on the other side in the first direction. Discharge ports 283, 284 are provided side by side in the upward/downward direction. Discharge port 284 is located above discharge port 283, for example.

Opening 263 is provided in a side surface of partition wall 214B on one side in the second direction. Opening 263 is opened toward sixth region 296. Opening 263 communicates with discharge port 283 via one of the two gas-discharge paths described above.

Opening 264 is provided in a side surface of partition wall 214B on the other side in the second direction. Opening 264 is opened toward sixth region 296. Opening 264 communicates with discharge port 284 via the other of the two gas-discharge paths described above.

It should be noted that external discharge ports 311 to 316 provided in end wall 303 of upper member 300 communicate with discharge ports 271 to 276, respectively. Similarly, external discharge ports 321 to 326 provided in end wall 304 of upper member 300 communicate with discharge ports 281 to 286, respectively.

Sealing member 221 seals a space between the lower portion of dividing wall 212 and bottom plate 220. Sealing member 221 is provided along a portion, extending in the second direction, of an outer peripheral edge portion of the lower surface of dividing wall 212. When gas is generated from at least one of the plurality of power storage stacks 101 disposed on one side in the first direction as described below, sealing member 221 suppresses debris or electrolyte solution discharged together with the gas from being moved toward sixth region 296 from fourth region 294 disposed on the other side in the first direction. Similarly, when gas is generated from at least one of the plurality of power storage slacks 101 disposed on the other side in the first direction, debris or electrolyte solution is suppressed from being moved toward third region 293 from first region 291 located on one side in the first direction. Thus, power storage stacks 101 arranged in the first direction can be suppressed from being short-circuited via the electrolyte solution or debris.

Heat insulating member 40 is disposed between each of the plurality of wall portions 210 and boarding space S. Specifically, heat insulating member 40 is disposed between each of the plurality of wall portions 210 and upper member 300. Heat insulating member 40 includes a first portion 41, a second portion 42, a third portion 43, and a fourth portion 44. Each of first portion 41, second portion 42, third portion 43, and fourth portion 44 extends along the first direction. First portion 41, second portion 42, third portion 43, and fourth portion 44 are arranged side by side at intervals in the second direction.

First portion 41 is disposed on the upper surface of side wall 211A. First portion 41 is located above the gas-discharge paths provided inside side wall 211A. Second portion 42 is disposed on the upper surface of partition wall 213A and the upper surface of partition wall 213B. Second portion 42 is located above the gas-discharge paths provided inside partition wall 213A and partition wall 213B. Third portion 43 is disposed on the upper surface of partition wall 214A and the upper surface of partition wall 214B. Third portion 43 is located above the gas-discharge paths provided inside partition wall 214A and partition wall 214B. Fourth portion 44 is disposed on the upper surface of side wall 211B. Fourth portion 44 is located above the gas-discharge paths provided inside side wall 211B.

In the above description, for example, when gas is discharged from power storage stack 101 disposed in first region 291, the gas is introduced into opening 251 and side wall opening 255 each opened toward first region 291. The gas introduced into opening 251 and side wall opening 255 passes through gas-discharge paths 231, 235 and discharge ports 271, 275, and is discharged to the outside of accommodation case 120 via external discharge ports 311, 315.

When gas is discharged from power storage stack 101 disposed in second region 292, the gas is introduced into openings 252, 253 each opened toward second region 292. The gas introduced into openings 252, 253 passes through gas-discharge paths 232, 233 and discharge ports 272, 273, and is discharged to the outside of accommodation case 120 via external discharge ports 312, 313.

When gas is discharged from power storage stack 101 disposed in third region 293, the gas is introduced into opening 254 and side wall opening 256 each opened toward third region 293. The gas introduced into opening 254 and side wall opening 256 passes through gas-discharge paths 234, 236 and discharge ports 274, 276, and is discharged to the outside of accommodation case 120 via external discharge ports 314, 316.

When gas is discharged from power storage stacks 101 disposed in fourth region 294 to sixth region 296, the gas passes through the gas-discharge paths provided in side walls 211A, 211B and partition walls 213B, 214B and through discharge ports 281 to 286 and is discharged to the outside of accommodation case 120 via external discharge ports 321 to 326 as with the case described above.

As described above, in vehicle 1 according to the present embodiment, when gas having a considerably high temperature is discharged from any one of the plurality of power storage stacks 101, the gas is discharged to the outside of accommodation case 120 through corresponding one(s) of the gas-discharge paths provided in side walls 211A, 211B and partition walls 213A, 213B, 214A, 214B. Here, since heat insulating member 40 is disposed between boarding space S and each of the plurality of wall portions 210 (side walls 211A, 211B and partition walls 213A, 213B, 214A, 214B) provided with the gas-discharge paths as described above, heat from the gas flowing through the gas-discharge path can be suppressed from being transferred to boarding space S.

Moreover, when heat insulating member 40 is disposed between upper member 300 and each of the plurality of wall portions 210 as described above, the heat from the gas flowing through the gas-discharge path can be suppressed from being transferred from each of the plurality of wall portions 210 to upper member 300, thereby suppressing the heat from being transferred from upper member 300 to boarding space S.

Further, as described above, since a portion of heat insulating member 40 is disposed between cross member 9 and accommodation case 120 (more specifically, upper member 300), the heat from the gas flowing through the gas-discharge path can be suppressed from being transferred from accommodation case 120 to cross member 9, thereby suppressing the heat from being transferred from cross member 9 to boarding space S.

### Second Embodiment

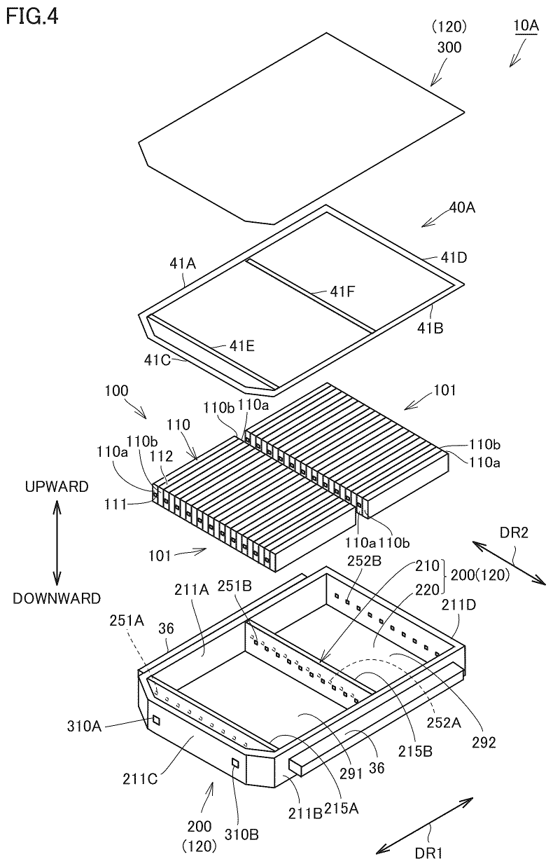

FIG. 4 is a schematic exploded perspective view of a power storage device according to a second embodiment. A power storage device 10A according to the second embodiment will be described with reference to FIG. 4.

As shown in FIG. 4, power storage device 10A according to the second embodiment is different from power storage device 10 according to the first embodiment mainly in terms of the configuration of accommodation case 120, the number of power storage stacks 101, and the shape and arrangement of a heat insulating member 40A. The other configurations are substantially the same.

In power storage device 10A according to the second embodiment, two power storage stacks 101 are disposed at an interval in the first direction. Lower case 200 has a substantially box shape that is opened upward. Upper member 300 has a substantially plate shape and closes an opening of lower case 200.

Lower case 200 includes a plurality of wall portions 210 and a bottom plate 220. The plurality of wall portions 210 include side walls 211A, 211B, partition walls 215A, 215B, and an end wall 211D. Lower case 200 further includes an end wall 211C. End wall 211C is provided with external discharge ports 310A, 310B. Gas-discharge paths are provided inside side walls 211A, 211B, partition walls 215A, 215B, and end walls 211D, 211C.

Side walls 211A, 211B and end walls 211C, 211D are provided to rise from an outer edge portion of bottom plate 220. Two partition walls 215A, 215B are disposed at an interval in the first direction. Partition wall 215A is located on one side with respect to partition wall 215B in the first direction. Partition wall 215B is disposed on a substantially central portion of bottom plate 220 in the first direction. Partition walls 215A, 215B each extend along the second direction. Two partition walls 215A, 215B are disposed on bottom plate 220 and partition a space in accommodation case 20 into three in the second direction.

A power storage stack 101 of two power storage stacks 101 on one side in the first direction is disposed in a first region 291 partitioned by side walls 211A, 211B and two partition walls 215A, 215B.

A power storage stack 101 of two power storage stacks 101 on the other side in the first direction is disposed in a second region 292 partitioned by side walls 211A, 211B, partition wall 215B, and end wall 211D.

Partition wall 215A is provided with a plurality of openings 251A each opened toward first region 291. Partition wall 215B is provided with a plurality of openings 251B each opened toward first region 291 and a plurality of openings 252A each opened toward second region 292. End wall 211D is provided with a plurality of openings 252B each opened toward second region 292.

The plurality of openings 251A face the plurality of gas-discharge valves 111 provided in the end surface, on one side in the first direction, of power storage stack 101 located on one side in the first direction. The plurality of openings 251B face the plurality of gas-discharge valves 111 provided in the end surface, on the other side in the first direction, of power storage stack 101 located on one side in the first direction. Thus, gas discharged from gas-discharge valves 111 can be directly introduced into partition walls 215A, 215B via openings 251A, 251B. The gas introduced into partition walls 215A, 215B passes through the gas-discharge paths and is discharged from external discharge ports 310A, 310B.

The plurality of openings 252A face the plurality of gas-discharge valves 111 provided in the end surface, on one side in the first direction, of power storage stack 101 located on the other side in the first direction. The plurality of openings 252B face the plurality of gas-discharge valves 111 provided in the end surface, on the other side in the first direction, of power storage stack 101 located on the other side in the first direction. Thus, gas discharged from gas-discharge valves 111 can be directly introduced into partition wall 215B and end wall 211D via openings 252A, 252B. The gas introduced into partition wall 215B and end wall 211D is discharged from external discharge ports 310A, 310B via the gas-discharge paths.

Heat insulating member 40A has a substantially frame shape and is disposed on the upper surfaces of the plurality of wall portions 210. Heat insulating member 40A includes a first portion 41A, a second portion 41B, a third portion 41C, a fourth portion 41D, a fifth portion 41E, and a sixth portion 41F.

First portion 41A is disposed on the upper surface of side wall 211A. First portion 41 is located above the gas-discharge paths provided inside side wall 211A. Second portion 41B is disposed on the upper surface of side wall 211B. Second portion 41B is located above the gas-discharge paths provided inside side wall 211B. Third portion 41C is disposed on the upper surface of end wall 211C. Third portion 41C is located above the gas-discharge paths provided inside end wall 211C.

Fourth portion 41D is disposed on the upper surface of end wall 211D. Fourth portion 41D is located above the gas-discharge paths provided inside end wall 211D. Fifth portion 41E is disposed on the upper surface of partition wall 215A. Fifth portion 41E is located above the gas-discharge paths provided inside partition wall 215A. Sixth portion 41F is disposed on the upper surface of partition wall 215B. Sixth portion 41F is located above the gas-discharge paths provided inside partition wall 215B.

Also in the case of the above-described configuration, in a vehicle including power storage device 10A according to the second embodiment, substantially the same effects as those of vehicle 1 according to the first embodiment can be obtained.

### Third Embodiment

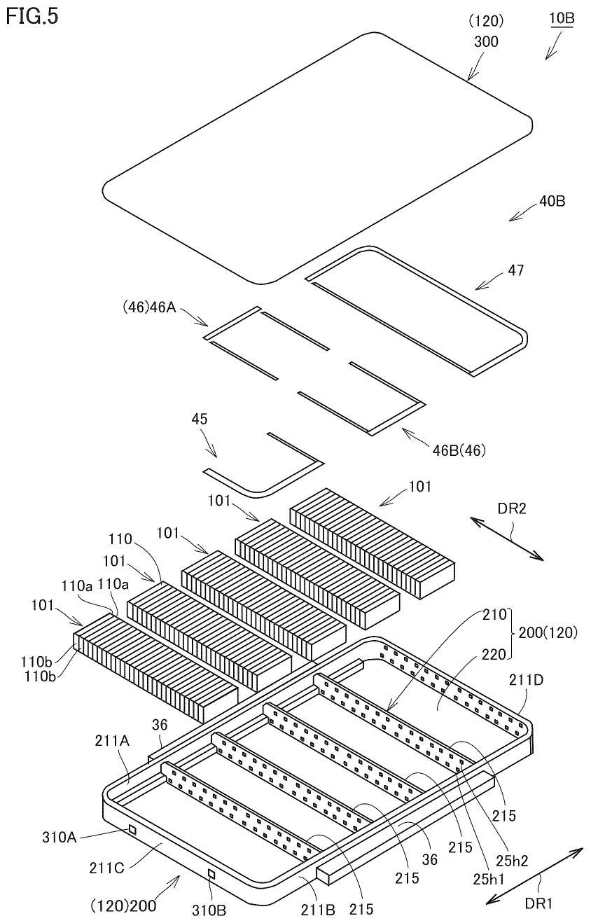

FIG. 5 is a schematic exploded perspective view of a power storage device according to a third embodiment. A power storage device 10B according to the third embodiment will be described with reference to FIG. 5.

Power storage device 10B according to the third embodiment is different from power storage device 10 according to the first embodiment mainly in terms of the configuration of accommodation case 120, the number of power storage stacks 101, and the shape and arrangement of heat insulating member 40B. The other configurations are substantially the same.

In power storage device 10B according to the third embodiment, the inside of accommodation case 120 is partitioned into five regions by four partition walls 215, and five power storage stacks 101 are disposed at intervals in the second direction. Five power storage stacks 101 are respectively disposed in the five regions partitioned by the pair of side walls 211A, 211B, the plurality of partition walls 215, and the pair of end walls 211C, 211D. It should be noted that the number of power storage stacks 101 is not limited to five, and one power storage stack 101 may be provided or two or more power storage stacks 101 may be provided. The number of partition walls 215 can be appropriately set in accordance with the number of power storage stacks 101. It should be noted that power storage stacks 101 may be arranged in the form of a matrix.

The plurality of power storage stacks 101 are arranged in the second direction such that first end surfaces 110a of the plurality of unit cells 110 included in each of power storage stacks 101 face the other side in the first direction. That is, in each power storage stack 101, all of the plurality of gas-discharge valves 111 face the other side in the first direction. The plurality of gas-discharge valves 111 are arranged in the second direction so as to be deviated alternately in the upward/downward direction.

Each of partition walls 215 is provided with a plurality of openings 25h1, 25h2 each opened toward a region located on one side in the first direction with respect to the partition wall. End wall 211D is also provided with a plurality of openings 25h1, 25h2 each opened toward a region located on one side in the first direction with respect to end wall 211D. The plurality of openings 25h1, 25h2 are arranged in the second direction so as to be deviated alternately in the upward/downward direction. The plurality of openings 25h1, 25h2 face the plurality of gas-discharge valves 111 included in power storage stack 101 located on one side in the first direction. Thus, gas discharged from gas-discharge valves 111 can be directly introduced into partition wall 215 or end wall 211D via openings 25h1, 25h2. The gas introduced into partition wall 215 and end wall 211D is discharged from external discharge ports 310A, 310B via the gas-discharge paths.

Heat insulating member 40B includes a first heat insulating member 45, a second heat insulating member 46, and a third heat insulating member 47.

First heat insulating member 45 is disposed between electrical device 73 (see FIG. 1) and a portion of the plurality of wall portions 210 located below electrical device 73. More specifically, first heat insulating member 45 is disposed between upper member 300 and the portion of the plurality of wall portions 210 located below electrical device 73 (see FIG. 1). First heat insulating member 45 has a substantially U-shape.

It should be noted that in the present embodiment, electrical device 73 is illustratively described as an in-vehicle ECU disposed near the feet of an occupant sitting on the passenger seat side; however, electrical device 73 is not limited to being arranged as described above, and may be disposed near the feet of an occupant sitting on the driver seat.

Further, electrical device 73 may include a car navigation system. In this case, the car navigation system is disposed on the front side (one side in the first direction) between the pair of front seats 71. First heat insulating member 45 may be disposed between the car navigation system and a portion of the plurality of wall portions 210 located below the car navigation system.

Second heat insulating member 46 is disposed between each of the pair of front seats 71 and a portion of the plurality of wall portions 210 located below each of the pair of front seats 71 (see FIG. 1). More specifically, second heat insulating member 46 is disposed between upper member 300 and the portion of the plurality of wall portions 210 located below each of the pair of front seats 71.

Second heat insulating member 46 includes a first portion 46A located below one of the pair of front seats 71 and a second portion 46B located at the other of the pair of front seats 71. First portion 46A and second portion 46B each have a substantially U-shape. First portion 46A and second portion 46B are disposed independently of each other. First portion 46A and second portion 46B are disposed at an interval in the second direction such that openings of the U-shapes face each other.

Third heat insulating member 47 is disposed between rear seat 72 (see FIG. 1) and a portion of the plurality of wall portions 210 located below rear seat 72. More specifically, third heat insulating member 47 is disposed between upper member 300 and the portion of the plurality of wall portions 210 located below rear seat 72. Third heat insulating member 47 has a substantially frame shape. Third heat insulating member 47 is disposed on an upper surface of end wall 211D, an upper surface of partition wall 215 closest to end wall 211D, and an upper surface of a portion of the pair of side walls 211A, 211B connecting end wall 211D and partition wall 215 closest to end wall 211D.

Also in the case of the above-described configuration, in a vehicle including power storage device 10B according to the third embodiment, substantially the same effects as those of vehicle 1 according to the first embodiment can be obtained. Moreover, since heat insulating member 40B includes first heat insulating member 45, heat from the gas flowing through the gas-discharge path can be suppressed from being transferred from wall portion 210 to electrical device 73. Moreover, since heat insulating member 40B includes second heat insulating member 46 and third heat insulating member 47, heat from the gas flowing through the gas-discharge path can be suppressed from being transferred from wall portion 210 to each of the pair of front seats 71 and rear seat 72.

It should be noted that in each of the first to third embodiments described above, it has been illustratively described that the first direction is parallel to the frontward/rearward direction of the vehicle and the second direction is parallel to the width direction of the vehicle in the mounted state; however, it is not limited thereto. In the mounted state, the first direction may be parallel to the width direction of the vehicle, and the second direction may be parallel to the frontward/rearward direction of the vehicle.

Although the embodiments of the present disclosure have been described and illustrated in detail, it is clearly understood that the same is by way of illustration and example only and is not to be taken by way of limitation. The scope of the present disclosure is defined by the terms of the claims, and is intended to include any modifications within the scope and meaning equivalent to the terms of the claims.

What is claimed is:

1. A vehicle comprising:
a vehicle body provided with a boarding space; and
a power storage device disposed below the boarding space, wherein
the power storage device includes one or more power storage stacks and an accommodation case that accommodates the one or more power storage stacks,
the accommodation case has a lower case in which the one or more power storage stacks are disposed, and a plurality of wall portions that partition a region in which the one or more power storage stacks are disposed,
a gas-discharge path through which gas discharged from the one or more power storage stacks is flowable is provided inside each of the plurality of wall portions, and
a heat insulating member is disposed between each of the plurality of wall portions and the boarding space.

2. The vehicle according to claim 1, wherein
the accommodation case has an upper member that seals an opening of the lower case, and
the heat insulating member is disposed between each of the plurality of wall portions and the upper member.

3. The vehicle according to claim 1, wherein
a cross member that constitutes a portion of a frame of the vehicle body is disposed between the boarding space and the accommodation case, and
a portion of the heat insulating member is disposed between the cross member and the accommodation case.

4. The vehicle according to claim 1, further comprising an electrical device disposed between the boarding space and the power storage device, wherein
the heat insulating member includes a first heat insulating member disposed between the electrical device and a portion of the plurality of wall portions located below the electrical device.

5. The vehicle according to claim 4, comprising a pair of front seats and a rear seat each disposed in the boarding space, wherein
the heat insulating member includes a second heat insulating member disposed between each of the pair of front seats and a portion of the plurality of wall portions located below each of the pair of front seats, and a third heat insulating member disposed between the rear seat and a portion of the plurality of wall portions located below the rear seat.
